(19) United States
(12) Patent Application Publication
(10) Pub. No.: US 2026/0001303 A1
(43) Pub. Date: Jan. 1, 2026

(54) MDO FILM FOR RECYCLABLE LAMINATE

(71) Applicant: RKW SE, Mannheim (DE)

(72) Inventors: Adrien DEMBOWSKI, Mannheim (DE); Claudia SPICKER, Mannheim (DE); Thomas TROH, Mannheim (DE); Claudia BENDER, Mannheim (DE); Frederic WYPELIER, Mannheim (DE); Leonhard MAIER, Babensham (DE); Konrad NONIEWICZ, Mannheim (DE)

(73) Assignee: RKW SE, Mannheim (DE)

(21) Appl. No.: 18/880,921

(22) PCT Filed: Jul. 3, 2023
(86) PCT No.: PCT/EP2023/068165

§ 371 Date: Jan. 3, 2025

(30) Foreign Application Priority Data
Jul. 4, 2022 (DE) 102022116661.9

(51) Int. Cl. B32B 7/02; B32B 27/08; B32B 27/30; B32B 27/32; B32B 27/34

(52) U.S. Cl. CPC B32B 7/02; B32B 27/08; B32B 27/306; B32B 27/32; B32B 27/34; B32B 2250/05; B32B 2250/24; B32B 2307/412; B32B 2307/516; B32B 2307/72; B32B 2307/7376

(57) ABSTRACT

A monoaxially stretched, transparent film for a recyclable laminate for packaging. The film comprises at least one outer layer and at least one inner layer. The at least one outer layer has a higher density than the at least one inner layer. The outer layer comprises a mixture of at least two polyethylenes of different densities, wherein the higher density polyethylene in at least one of the outer layers has a density of more than 0.94 g/cm³ and the lower density polyethylene in at least one of the outer layers has a density of less than 0.94 g/cm³.

### CROSS REFERENCE TO RELATED APPLICATIONS

This application is a 371 National Phase of PCT/EP2023/068165, filed Jul. 3, 2022, which claims priority from German Patent Application No. 10 2022 116 661.9, filed Jul. 4, 2022, both of which are incorporated herein by reference as if fully set forth.

### TECHNICAL FIELD

The invention relates to a monoaxially stretched, transparent film for a recyclable laminate, wherein the film comprises at least one outer layer and at least one inner layer.

### BACKGROUND

Current, commercially available plastic packaging is often film laminates made of different layers that are customised with regard to their application and function, e.g. polyolefins such as polyethylene (PE) and/or polypropylene (PP), often combined with polyethylene terephthalate (PET) and/or polyamide (PA) to achieve the desired physical film properties.

Polyethylene has proven its worth in the manufacture of food packaging films, food bags, stretch films, shrink films, bin liners and mailing bags. Conventional blown or cast polyethylene films are often used for flexible packaging as individual packaging or as laminate film.

At the same time, the way in which plastic, and therefore also packaging films, are currently produced and disposed of can also be harmful to the environment under certain circumstances. The consequences range from high CO₂ emissions to pollution of the oceans. To counteract this, the European Union wants to reduce the landfilling of plastic waste as part of its “Green Deal”. By 2030, 55% of plastic packaging waste is to be recycled

In order to meet the challenges of recycling, the design of packaging must become increasingly sustainable. This can be achieved, for example, by realising and implementing more mono-material designs. The challenge here is to realise the very different properties of packaging, which were previously achieved by combining different plastic layers with different material bases, with just one recyclable mono-material construction.

It has been shown that biaxially oriented polypropylene films and biaxially oriented polyethylene films and cast polypropylene films offer good stiffness and toughness and can be made thinner.

A machine direction orientation gives films good stiffness and optical properties that are advantageous for applying a printed image. However, if they are strongly oriented in the machine direction, the tear resistance of the films can decrease significantly, which makes printability in modern line printing processes with high web speeds problematic. In addition, films with a high degree of stretching can be expected to exhibit fibrillation, which can impair the value and possibly the appearance of a print.

EP 3 317 100 B1 discloses a uniaxially oriented film having a first layer comprising a first composition comprising an ethylene-based polymer prepared in the presence of a single-site catalyst, the first composition having a density of 0.935 g/cm³ to 0.965 g/cm³, a melt index of 0.5 to 6 g/10 min and a molecular weight distribution of 6.0 or less, and a Ziegler-Natta catalysed ultra-low density polyethylene having a density of 0.880 g/cm³ to 0.912 g/cm³, a melt index of 0.5 to 6 g/10 min and a MWD of 6.0 or less; a second layer comprising at least one polyolefin; and at least one inner layer between the first layer and the second layer comprising a high density polyethylene or a Ziegler-Natta catalysed ultra-low density polyethylene having a density from 0.880 g/cm³ to 0.912 g/cm³ and a melt index from 0.5 to 6 g/10 min, the film being oriented in the machine direction at a draw ratio of between 4:1 and 10:1 and the film has a 2 per cent secant modulus of 590 MPa or more in the machine direction.

EP 3 481 630 B1 describes a recyclable polyethylene film made of at least 80% polyethylene material and a maximum of 20% compatible polyolefin material, wherein the polyethylene film is less than 40 μm thick and has a central layer of linear low-density polyethylene and/or linear metallocene low-density polyethylene and two outer layers of high-density polyethylene connected to the central layer and surrounding the central layer, wherein the HDPE content of the polyethylene film is at least 60 vol. % by volume, preferably at least 70% by volume, most preferably at least 80% by volume, and wherein the polyethylene film is stretched in at least one direction and the two outer layers together are at least three times as thick, preferably at least four times as thick, as the central layer. In this film, polypropylene or cyclo-olefin copolymer must be mixed into the outer layers in order to achieve sufficient heat resistance, which means that a monomaterial construction is no longer realised.

EP 2 860 031 B1 discloses a multilayer film stretched in the machine direction and suitable for labels, comprising a core layer and two outer layers sandwiched around the core layer, wherein the core layer comprises a bimodal ethylene/1-butene/C6-C12-alpha-olefin terpolymer with a density between926 kg/m³ to 950 kg/m³ and the two outer layers comprise unimodal HDPE with a density of more than 940 kg/m³ up to 970 kg/m³.

WO 2021/076 552 A1 discloses a polyethylene film oriented in the machine direction with a core layer comprising a first ethylene-based polymer with a density of 0.870 g/cm³ to 0.920 g/cm³ and a peak melting point of 82 to 126° C. and a weight-related crystallinity of 15 to 30 as well as an outer layer, comprising a second ethylene-based polymer with a density of 0.940 g/cm³ to 0.965 g/cm³ and a peak melting point of 130 to 135° C. and a weight-based crystallinity of 30 to 80, and a sub-skin layer, located between and in contact with the core layer and the outer layer, the sub-skin layer comprising a third ethylene-based polymer having a density of from 0.920 g/cm³ to 0.950 g/cm³ and a peak melting point of from 125 to 130° C. and a weight percent crystallinity of from 40 to 65, wherein the ratio of the weight percent crystallinity of the core layer to the skin layer has a value of from 0.25 to 0.91. In particular, the use of low-density polyethylene, which is used to give the films sufficient toughness, favours fibrillation at high stretch ratios in the machine direction.

EP 3 390 049 B1 discloses a laminated polyethylene-based film structure with barrier properties, comprising an oriented first film, which is oriented at least in the machine direction with at least one layer A based on polyethylene polymer having a density of 890 to 980 kg/m³ and optionally at least one layer B of high density polyethylene (HDPE) having a density of 940 to 970 kg/m³ or medium density polyethylene (MDPE) having a density of 925 to 940 kg/m3 or a linear low density polyethylene (LLDPE) having a density of 910 to 950 kg/m³, wherein the oriented first film is oriented at least in the machine direction at a stretch ratio of 1:1.5 to 1:12 and has a film thickness of 10 to 50 μm after orientation and wherein the oriented first film is coated by a thin vapour-deposited ceramic or metal barrier layer on a surface of the oriented first film, wherein the oriented first film is laminated with the coated surface onto a second film. The polyethylene polymer of layer A is selected from high density polyethylene (HDPE), medium density polyethylene (MDPE) or a linear low density polyethylene (LLDPE) or blends of linear low density polyethylene (LLDPE) with high pressure low density polyethylene (LDPE) or a blend of an ethylene-based plastomer with high pressure low density polyethylene (LDPE).

High-quality packaging laminates also usually have an imprint that is realised using a line printing process, e.g. gravure printing or flexographic line printing. For this reason, PET or PP film webs are often used as the printed film web in such film laminates. Currently, printed film webs with layer thicknesses of just 12 μm are used for this purpose. However, the construction of monolaminates made of polyethylene causes the problem of qualitative printability with such low layer thicknesses.

### SUMMARY

The object of the present invention is to provide a film for a recyclable laminate that fulfils the requirements of a monomaterial construction and can guarantee good mechanical properties. For this purpose, the film should be particularly stiff and have sufficient toughness without a tendency to fibrillate. In addition, the film should have sufficient heat resistance and be easy to recycle. At least one layer of the film or one layer of the laminate should have the required sealing properties. It should be possible to print the film cheaply and in excellent quality. The film should be harmless to health and ecologically sustainable. In addition, the film should not emit any odours.

According to the invention, this object is ensured by a film for a recyclable laminate according to the main claim. Preferred variants can be found in the subclaims, the description and the drawings.

According to the invention, at least one outer layer has a higher density than the at least one inner layer. The outer layer comprises a mixture of at least two polyethylenes of different densities, wherein the polyethylene of higher density has a density of more than 0.94 g/cm³ and the polyethylene of lower density has a density of less than 0.94 g/cm³.

Advantageously, the proportion of the higher density polyethylene in at least one of the outer layers in the mixture is more than 40% by weight, preferably more than 60% by weight, in particular more than 80% by weight and/or less than 95% by weight, preferably less than 90% by weight, in particular less than 85% by weight. The proportion of high-density polyethylene gives the film excellent stiffness and heat resistance.

In a particularly favourable variant of the invention, the proportion of the low-density polyethylene in at least one of the outer layers in the mixture is more than 5% by weight, preferably more than 10% by weight, in particular more than 15% by weight and/or less than 60% by weight, preferably less than 40% by weight, in particular less than 20% by weight. The proportion of low-density polyethylene ensures a favourable toughness of the film.

Ideally, the density of the higher density polyethylene is greater than the lower density polyethylene by a factor, the value of the factor being more than 1.002, preferably more than 1.005, in particular more than 1.008 and/or less than 1.20, preferably less than 1.15, in particular less than 1.10.

The flow behaviour of polyolefins is described using the melt flow rate according to ISO 1133-1, usually at a temperature of 190° C. for polyethylene and 230° C. for polypropylene at a load of 2.16 kg, 5 kg or 21.6 kg. A higher melt flow index correlates with a lower average molecular weight of the polymer. At the same time, the higher the melt index of a polymer, the lower the melt viscosity, which is favourable for a high output of the extrusion system. On the other hand, polymers with a high molecular weight, i.e. a low melt index, are advantageous in terms of mechanical stability, in particular tensile strength and toughness.

For example, the inner or For example, the inner or an inner layer is formed from a polyethylene whose density according to ISO 1183-1 is more than 0.91 g/cm³, preferably more than 0.92 g/cm³ and/or is less than 0.95 g/cm³, preferably less than 0.94 g/cm³ and/or whose melt flow rate (at 190° C. at 5 kg) according to ISO 1133-1 is more than 0.1 g/10 min, preferably more than 1.0 g/10 min and/or is less than 5.0 g/10 min, preferably less than 3.0 g/10 min.

In one variant of the invention, the inner layer is made of a polyethylene whose density is 0.937 g/cm³ according to ISO 1183-1.

Advantageously, the polyethylene of the inner layer has a melt flow rate according to ISO 1133-1 of more than 1.0 g/10 min, preferably more than 1.5 g/10 min, in particular more than 1.9 g/10 min and/or less than 4.0 g/10 min, preferably less than 3.0 g/10 min, in particular less than 2.1 g/10 min at 190° C. and 5 kg.

Furthermore, the melt flow rate according to ISO 1133-1 of the polyethylene of the inner layer is more than 20 g/10 min, preferably more than 30 g/10 min, in particular more than 40 g/10 min and/or less than 65 g/10 min, preferably less than 55 g/10 min, in particular less than 45 g/10 min at 190° C. and 21.6 kg. As a result, the polyethylene in the inner layer as well as for the entire film achieves a high toughness and simultaneously high stiffness values.

For example, the polyethylene of the inner layer has a tensile elasticity TD of more than 730 MPa, a tensile strength MD of more than 60 MPa and a melting temperature of more than 127° C. These special physical parameters result in a film that can fulfil the task at hand.

In a variant of the invention, the polyethylene of the inner layer has a bimodal molecular weight distribution.

In a particularly preferred variant, the film comprises more than one inner layer, preferably more than two inner layers, in particular more than four inner layers, all of which are formed from the same polyethylene. This special multi-layer construction gives the film a particularly high degree of toughness and stiffness, while at the same time preventing the formation of fibrils in a particularly advantageous manner.

Preferably, the high-density polyethylene has a medium molecular weight and a particularly narrow molecular weight distribution, which leads to good bubble stability and processability. Furthermore, the outer layer or layers have excellent tensile strength and good elongation at break with a low tendency to fibrillate. This means that the film can be printed with particular precision and high quality, as the web tension can be achieved precisely during printing, even at high web speeds, while the film web is particularly thin.

Ideally, the higher density polyethylene is formed in at least one of the outer layers from an HDPE whose density is more than 0.942 g/cm³, preferably more than 0.944 g/cm³ and/or less than 0.97 g/cm³, preferably less than 0,965 g/cm³ and/or whose melt flow rate (at 190° C. at 21.6 kg) according to ISO 1133-1 is more than 5 g/10 min, preferably more than 10 g/10 min and/or less than 25 g/10 min, preferably less than 20 g/10 min.

Ideally, the HDPE in at least one of the outer layers has a melt flow rate according to ISO 1133-1 of more than 1.0 g/10 min, preferably more than 1.25 g/10 min, in particular more than 1.5 g/10 min and/or less than 3.0 g/10 min, preferably less than 2.0 g/10 min, in particular less than 1.75 g/10 min at 190° C. and 5 kg.

Furthermore, the melt flow rate according to ISO 1133-1 of the HDPE in at least one of the outer layers is more than 11 g/10 min, preferably more than 13 g/10 min, in particular more than 15 g/10 min and/or less than 30 g/10 min, preferably less than 20 g/10 min, in particular less than 17 g/10 min at 190° C. and 21.6 kg.

For example, the HDPE has a tensile elasticity of more than 880 MPa, a tensile strength of more than 20 MPa and a melting temperature of more than 129° C. in at least one of the outer layers. These special physical parameters result in a film that can fulfil the task at hand.

In an alternative variant of the invention, the HDPE in at least one of the outer layers has a melt flow rate according to ASTM D1238 of more than 0.1 g/10 min, preferably of more than 0.5 g/10 min, in particular of more than 0.8 g/10 min and/or less than 3.0 g/10 min, preferably of less than 2.0 g/10 min, in particular of less than 1.0 g/10 min at 190° C. and 2.16 kg. For example, this HDPE has a density of more than 0.961 g/cm3 according to ASTM D792 and a tear strength according to Elmendorf of more than 40 g in MD and more than 165 g in TD.

For better adhesion of a high-quality print, the outer layers of the film are made of a high proportion of HDPE, which may also contain a proportion of additives in addition to the low proportion of low-density polyethylene.

Preferably, the high-density polyethylene has a medium molecular weight and a particularly narrow molecular weight distribution, which leads to good bubble stability and processability. Furthermore, the outer layers have excellent tensile strength and good elongation at break with a low tendency to fibrillate.

Advantageously, the low-density polyethylene is formed in at least one of the outer layers from a polyethylene whose density is more than 0.91 g/cm³, preferably more than 0.92 g/cm³ and/or less than 0.95 g/cm³, preferably less than 0.94 g/cm³ and/or whose melt flow rate (at 190° C. at 5 kg) according to ISO 1133-1 is more than 0.1 g/10 min, preferably more than 1.0 g/10 min and/or less than 5.0 g/10 min, preferably less than 3.0 g/10 min.

For example, the low-density polyethylene is formed in at least one of the outer layers from a bimodal polyethylene, preferably from a bimodal terpolymer, in particular from a bimodal ethylene/1-butene/C₆-C₁₂-alpha-olefin terpolymer. The combination of low molecular weight, high density polymer chains and high molecular weight, low density polymer chains results in a combination of stiffness and flexibility in the polyethylene in at least one of the outer layers. This enables an optimal balance between strength, impact resistance, stiffness and processability of the resulting polyethylene in at least one of the outer layers.

In a particularly simple embodiment of the invention, the film comprises three layers. The inner layer is preferably made of a polyethylene with a density of, for example, 0.937 g/cm³, while the two outer layers are formed from a polymer mixture of HDPE and the polyethylene with a density of, for example, 0.937 g/cm³.

In a particularly advantageous variant of the invention, the film comprises a nine-layer structure. Preferably, three equally thin inner layers of a polyethylene with a density of, for example, 0.937 g/cm³ form the core of the film, each of which is surrounded by an inner intermediate layer. Ideally, the inner intermediate layers are also formed from a polyethylene with a density of, for example, 0.937 g/cm³ and are approximately twice as thick as the inner layers. An outer intermediate layer is arranged between the inner intermediate layer and the outer layer. The outer intermediate layer is somewhat thicker than the inner intermediate layer and preferably consists of a mixture of higher and lower density polyethylene. The outer layer has a thickness that is again slightly thicker than the thickness of the outer intermediate layer and also consists of a mixture of high-density and low-density polyethylene, whereby the outer layer also has a small proportion of additives.

In a nine-layer structure, for example, the thickness of the inner layers is more than 5 μm and/or less than 7 μm before stretching.

In a nine-layer structure, for example, the thickness of the inner intermediate layers is more than 10 μm and/or less than 15 μm before stretching.

In the nine-layer structure, the thickness of the outer intermediate layers is, for example, more than 15 μm and/or less than 20 μm before stretching. For example, the outer intermediate layer, which is arranged towards the print, is slightly thicker—approx. 19 μm—than the outer intermediate layer, which is arranged on the side facing away from the print—approx. 16 μm.

In the nine-layer structure, the thickness of the outer layers is, for example, more than 15 μm and/or less than 22 μm before stretching. For example, the outer layer, which is arranged towards the print, is slightly thicker—approx. 20 μm—than the outer layer, which is arranged on the side facing away from the print—approx. 17 μm.

In principle, five-layer and seven-layer films are also included within the scope of the invention, whereby the mechanical properties can be realised more effectively with an increasing number of layers.

In one variant of the invention, the thickness of the layers increases from the inner layer to the outer layer. This applies to the three-layer film up to the nine-layer film. This design of the film achieves particularly advantageous mechanical properties and thus realises a film that can be printed to a high quality.

In a further variant of the invention, the inner layer is thicker than one of the outer layers, with the inner layer being thicker than one of the outer layers by a factor of more than 1.3, preferably by a factor of more than 1.6, in particular by a factor of more than 1.9. This can be the case, for example, with a three-layer variant of the film.

The favourable mechanical properties have so far only been known from films based on a material mix of different thermoplastics. The mono-material construction according to the invention is characterised by complete and simple recyclability.

In order to achieve the advantageous mechanical properties, the film is ideally stretched monoaxially in the machine direction by more than a factor of 2.0, preferably by more than a factor of 3.0, in particular by more than a factor of 4.0, and/or is stretched by less than a factor of 7.0, preferably by less than a factor of 6.5, in particular by less than a factor of 6.0.

The thickness of the film was measured in accordance with DIN 53370 and specified as an average value. Advantageously, the film has a thickness of less than 60 μm, preferably less than 50 μm, in particular less than 40 μm and/or more than 5 μm, preferably more than 10 μm, in particular more than 15 μm. The film is thus designed to be as thin and material-saving as possible, so that it is nevertheless suitable for the application of a high-quality print.

Flexographic printing is a frequently used process for printing on film. This is a direct letterpress process, which is also known as a web-fed rotary printing process. The flexible printing plates, which are made of photopolymer or rubber, are used in combination with low-viscosity printing inks. The raised areas of the printing plate are image-bearing. The advantages lie in the economic efficiency through the utilisation of a large printing width and a high printing speed, as well as the availability of cost-effective printing inks. The printing tools essentially consist of photopolymer printing plates and/or laser-engraved elastomer sleeves. Large print runs can be realised economically with flexographic printing.

Preferably, the print is arranged directly on an outer layer of the film. The print or imprint can be arranged on the side facing away from the packaged goods or between the film and the layer in the form of a counterprint. The print can be designed as a print motif. In the area of film, the term print motif refers to the thematic design part of an imprint. If necessary, print motifs that characterise the manufacturer can also be included in the scope of the print.

Preferably, the imprint is applied to an outer layer of the film using a flexographic printing process, whereby all conventional printing processes are in principle suitable for this purpose and are expressly included in the invention.

The special selection of polymers as well as the design in a three-to nine-layer variant realise a particularly thin film that nevertheless has convincing mechanical properties, even in the design of a mono-material construction. Despite the thin design, the stiffness and simultaneous toughness, which are realised in particular by the polyethylene mixture in at least one outer layer, result in excellent printability. In addition, the film is combined with at least one layer to form a packaging laminate, whereby a large selection of sealing layers, which can be sealed at low temperatures, is possible.

In a favourable variant of the invention, the multilayer structure of the film is symmetrical, whereby the printability of both outer layers can be realised and can therefore be varied flexibly between the printing arrangement on the outside or the reverse printing.

To realise the recyclability and thus also the sorting in modern waste separation plants, such as the float-sink process, the density of the film is less than 0.99 g/cm³, preferably less than 0.98 g/cm³, in particular less than 0.97 g/cm³ and/or more than 0.60 g/cm³, preferably more than 0.70 g/cm³, in particular more than 0.80 g/cm³.

The haze value is a measure of the haze or gloss of transparent films. The method for measuring the haze value is described in the ASTM D 1003 standard and DIN EN ISO 2813. Favourably, the film has a gloss according to DIN EN ISO 2813 of less than 7%, preferably less than 6%, in particular less than 5%. This gives the laminate and the film a particularly high-quality appearance.

Heat sealing is a common method for producing seals and seams on flexible packaging. Adhesive systems are also occasionally used. There are a variety of types of heat sealing. The most common, especially for films, are heat sealing, bar sealing and impulse sealing.

Suitable film layers for heat-sealing are LDPE and LLDPE, which can then be sealed with the film to form a laminate. LDPE has better heat-sealing properties than LLDPE. It seals at lower temperatures, seals over a wider temperature range and has better heat tack, which is largely due to the long-chain branching. Metallocene LLDPE with higher alpha olefins was developed to overcome this disadvantage of LLDPE. Another approach to achieving the best blend of properties for a particular application is to blend LLDPE and LDPE.

Thermal sealing uses two heated bars that exert pressure on the films to be sealed and simultaneously conduct heat to the interface, causing the films to melt at these points. The pressure ensures good contact between the films and supports the penetration of the molten viscous materials at the interface. After sufficient sealing time, the pressure is released from the bars and the films are released. Therefore, the hot tack of the film material is critical to the formation of an adequate seal. The full strength of the seal forms as the film material cools, but the initial strength must be sufficient to maintain the integrity of the seal during cooling.

The sealing bars usually have rounded edges to avoid puncturing the material, and often one bar is provided with a resilient surface to ensure even pressure during sealing. The sealing jaws are usually not flat but serrated and create a patterned seal. In variants of thermal sealing, only one bar is heated and the other is not. Another variant uses heated rollers instead of bars, for example a bag is sealed as it passes through the rollers.

In order to design a film with particularly advantageous sealing properties, at least one outer layer has a proportion of polypropylene, the proportion being more than 5% by weight, preferably more than 10% by weight, in particular more than 15% by weight and/or less than 50% by weight, preferably less than 40% by weight, in particular less than 30% by weight. The proportion of polypropylene increases the heat resistance and thus also the temperature at which the film can be sealed without undermining the recyclability of the film.

Ideally, the layer has a thickness of more than 10 μm, preferably more than 15 μm, in particular more than 20 μm and/or less than 100 μm, preferably less than 80 μm, in particular less than 60 μm. Thus, depending on the use of the film, a thin sealing layer can be realised or, for example, a thick sealing layer when enclosing liquids.

Advantageously, the layer used to seal the film into a laminate is formed from an LDPE and/or an LLDPE. Low density polyethylene (LDPE) is a thermoplastic made from the monomer ethylene. LDPE has more branches (on about 2% of the carbon atoms) than HDPE, so its intermolecular forces are weaker, its tensile strength is lower and its elasticity is higher. The side branches mean that the molecules are less densely packed and less crystalline, which is why the density is lower.

The production of LLDPE is initiated by transition metal catalysts, in particular Ziegler or Philips type catalysts. The actual polymerisation process can be carried out either in the solution phase or in gas phase reactors. As a rule, octene is the comonomer in the solution phase, while butene and hexene are copolymerised with ethylene in a gas phase reactor. LLDPE has a higher tensile strength and a higher impact and puncture resistance than LDPE. It is very flexible and expands under load. It can be used to produce thinner films that have better resistance to stress cracking. It has good resistance to chemicals. It has good electrical properties. However, it is not as easy to process as LDPE, has a lower gloss and a narrower range for heat sealing.

In a particularly favourable variant of the invention, the film including the layer is formed entirely from polyethylene. Polyethylene (PE) is a thermoplastic produced by chain polymerisation of petrochemically produced ethylene. Polyethylene is semi-crystalline and non-polar. As a result, the film fulfils the requirements of the Plastics Pact, is based on a mono-material construction and is recyclable.

In an alternative variant of the invention, the film has at least one additional outer layer of ethylene-vinyl alcohol copolymer layer (EVOH) and/or polyamide (PA). This additional layer can be formed as an outer layer, to which the print adheres better due to the higher polarity of the outer layer. At the same time, this additional outer layer improves the heat deflection temperature and the stiffness of the film. For this purpose, the additional layer of EVOH and/or PA is particularly thin, so that the proportion of material in the overall film is particularly low and the film is considered a mono-material construction in terms of recycling.

In a variant of the invention, the film comprises at least one further outer layer for producing a matt film surface.

For example, the further outer layer has no fillers, wherein the film has a haze value according to ASTM D1003 of more than 65%, preferably more than 75%, in particular more than 85%, due to the further outer layer.

The other outer layer has a thickness of more than 4 μm and/or less than 10 μm, for example.

For example, the additional outer layer can be arranged on the side of the film facing away from the print and/or visible from the outside. The matt surface gives the film a favourable appearance.

In an alternative variant of the invention, at least one of the layers can have a proportion of LLDPE in order to increase the elasticity and thus also the Elmendorf tear resistance of the film.

According to the invention, the process for producing a film for a recyclable laminate comprises several steps. Firstly, at least two compositions of the polymeric components are produced, which are then extruded to form a film with at least three, ideally nine layers. The polymer mixtures differ in terms of the outer and inner layers. Advantageously, the film is stretched monoaxially in the machine direction, which achieves the favourable properties in terms of overall density below 0.99 g/cm³, transparency and printability, stiffness and toughness of the film. The film can then be printed directly and laminated with a single layer.

Ideally, extrusion is carried out as blow extrusion, which favours the formation of advantageous film characteristics such as stiffness.

The film is produced by monoaxial stretching with a machine direction orientation by heating the film to a temperature slightly below its melting point and stretching it in a specific orientation. Stretching can also take place directly after extrusion, where the film is still at a temperature slightly below its melting point.

In an advantageous variant of the invention, the film is stretched monoaxially in the machine direction by more than a factor of 2.0, preferably by more than a factor of 3.0, in particular by more than a factor of 4.0 and/or stretched by less than a factor of 7.0, preferably by less than a factor of 6.5, in particular by less than a factor of 6.0. This gives the film an advantageous stiffness and a favourable transparency and at the same time the density of the film has a value of less than 0.99 g/cm³.

According to the invention, the film is used as a recyclable print carrier film for packaging laminates.

### BRIEF DESCRIPTION OF THE DRAWINGS

Further advantages and features of the invention can be seen from the description of an embodiment example with reference to a drawing and from the drawing itself. It shows:

FIG. 1 shows a schematic structure of the film according to the invention in the form of a laminate,

FIG. 2 a further design variant of the film.

### DETAILED DESCRIPTION

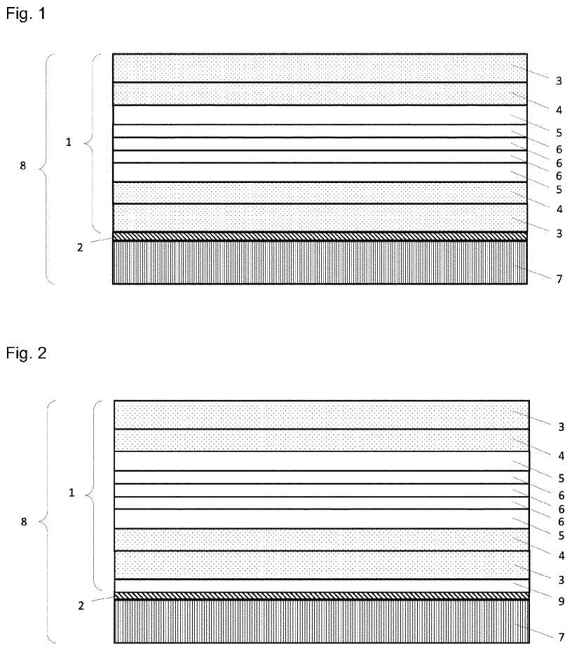

FIG. 1 shows a schematic structure of the laminate 8, which is formed from the film 1 and the layer 7. A print 2 is arranged directly on an outer layer 3 of the transparent film 1 in the form of a reverse print. The print 2 is used for labelling the item to be packaged and for visual recognition as well as for supporting a brand image of the item brand.

In this embodiment, the film 1 is designed with nine layers in a symmetrical structure whose respective layer thickness increases from the inner layer 6 to the outer layer 3. Furthermore, the density of the polymers also increases from the inside to the outside. In this embodiment, the inner layer 6 is triple as well as extremely thin, with approx. 6 μm in each case before stretching, and is made of a polyethylene whose density is 0.937 g/cm³ and whose melt flow rate (at 190° C. at 5 kg) is 2 g/10 min in accordance with ISO 1133.

The three inner layers 6 are each surrounded by an inner intermediate layer 5, which is approximately twice as thick as the inner layer 6 and is made of the polyethylene described above.

An outer intermediate layer 4 is arranged between the inner intermediate layer 5 and the outer layer 3, whereby the layer thickness of the outer intermediate layer 4 is somewhat thicker than the inner intermediate layer 5, at approx. 16-19 μm before stretching. The outer intermediate layer 4 consists of a mixture of two polyethylenes, whereby in this embodiment the proportion of high-density polyethylene is 85% by weight and the proportion of low-density polyethylene is 15% by weight.

In addition to a proportion of additives (a highly transparent silica-based anti-block and IR filter masterbatch in PE carrier resin and/or a processing aid for levelling the flowability of the melt) of 2% by weight, the outer layers 3 of film 1 consist of a mixture of two polyethylenes, whereby in this embodiment the proportion of high-density polyethylene is 83% by weight and the proportion of low-density polyethylene is 15% by weight. The layer thickness of the outer layers 3 is between 17-20 μm before stretching.

In the embodiment shown, the higher density polyethylene of the outer layers 3 and the outer intermediate layers 4 is designed as an HDPE whose density is 0.946 g/cm³ and whose melt flow rate (at 190° C. at 5 kg) is 1.6 g/10 min according to ISO 1133.

In the embodiment shown, the low-density polyethylene of the outer layers 3 and the outer intermediate layers 4 is a polyethylene whose density is 0.937 g/cm³ and whose melt flow rate (at 190° C. at 5 kg) is 2 g/10 min according to ISO 1133.

The nine-layer film 1 has a thickness of 119 μm after blow extrusion. After monoaxial stretching by a factor of 5.95, the thickness is 20 μm, with a density of 0.93 g/cm³.

The special selection of polymers as well as the design in the nine-layer variant realise a particularly thin film 1, which nevertheless has convincing mechanical properties, even in the design of a mono-material construction. The layer 7 is formed from an LDPE.

FIG. 2 shows a schematic representation of a further embodiment of the laminate 8, which essentially corresponds to the embodiment in FIG. 1.

In the embodiment shown in FIG. 2, the higher density polyethylene of the outer layers 3 and the outer intermediate layers 4 is designed as an HDPE whose density is 0.962 g/cm³ and whose melt flow rate (at 190° C. at 2.16 kg) is 0.85 g/10 min according to ASTM 1238.

In addition, the film 1 has an optional outer layer 9, which is formed from an ethylene-vinyl alcohol copolymer layer (EVOH). In the embodiment shown, the thickness of the outer layer 9 after stretching is 4 μm and is formed from a SoamoL™ from Mitsubishi Chemicals.

1. A monoaxially stretched, transparent film (1) for a recyclable laminate (8) for packaging; the film (1) comprising:
at least one outer layer (3) and at least one inner layer (6);
the at least one outer layer (3) having a higher density than the at least one inner layer (6);
the at least one outer layer (3) comprising a mixture of at least two polyethylenes of different densities, the polyethylene of higher density in the at least one of the outer layers (3) having a density of more than 0.94 g/cm³; and the polyethylene of lower density in the at least one of the outer layers (3) having a density of less than 0.94 g/cm³.

2. The film according to claim 1, wherein a proportion of the higher density polyethylene in the at least one of the outer layers (3) in the mixture is more than 40% by weight and less than 95% by weight.

3. The film according to claim 1, wherein proportion of low-density polyethylene in the at least one of the outer layers (3) in the mixture is more than 5% by weight and less than 60% by weight.

4. The film according to claim 1, wherein the density of the higher density polyethylene in the at least one of the outer layers (3) is greater by a factor than the lower density polyethylene in at least one of the outer layers (3), the value of the factor being more than 1.002 and less than 1.20.

5. The film according to claim 1, wherein the at least one inner layer (6) is formed from a polyethylene having a whose density of more than 0.91 g/cm³ and less than 0.95 g/cm³ and having a melt flow rate (at 190° C. at 2.16 kg) according to ASTM D 1238 of more than 0.1 g/10 min and of less than 5.0 g/10 min.

6. The film according to claim 1, wherein the higher density polyethylene in the at least one of the outer layers (3) is formed from an HDPE having a density of more than 0.942 g/cm³, and less than 0.97 g/cm³ and having a melt flow rate (at 190° C. at 2.16 kg) according to ASTM D 1238 of more than 5 g/10 min and of less than 25 g/10 min.

7. The film according to claim 1, wherein the low-density polyethylene in the at least one of the outer layers (3) is formed from a polyethylene having a density of more than 0.91 g/cm³ and of less than 0.95 g/cm³ and having a melt flow rate (at 190° C. at 2.16 kg) according to ASTM D 1238 of more than 0.1 g/10 min and of less than 5.0 g/10 min.

8. The film according to claim 1, wherein the low-density polyethylene in at least one of the outer layers (3) comprises a bimodal polyethylene, wherein the bimodal polyethylene is a terpolymer, and further wherein the terpolymer is a bimodal ethylene/1-butene/C6-C12-alpha-olefin terpolymer.

9. The film according to claim 1, wherein a thickness of the layers increases from the at least one inner layer (6) to the at least one outer layer (3).

10. The film according to claim 1, wherein the at least one inner layer (6) is thicker than one of the outer layers (3), the at least one inner layer (6) being thicker than the one of the outer layers (3) by more than a factor of 1.3.

11. The film according to claim 1, wherein the film (1) is stretched monoaxially in a machine direction by more than a factor of 2.0 and is stretched in the machine direction by less than a factor of 7.0.

12. The film according to claim 1, wherein the film (1) has a thickness of less than 60 μm and more than 5 μm.

13. The film according to claim 1, wherein a print (2) is arranged directly on the at least one outer layer (3) of the film (1).

14. The film according to claim 1, wherein the multilayer structure of the film (1) is symmetrical.

15. The film according to claim 1, wherein a density of the film (1) is less than 0.99 g/cm³ and is more than 0.60 g/cm³.

16. The film according to claim 1, wherein the film (1) has a gloss according to DIN EN ISO 2813 of less than 7%.

17. The film according to claim 1, wherein the film (1) has at least one additional outer layer (9) which is formed from an ethylene-vinyl alcohol copolymer layer (EVOH) or from polyamide (PA).

18. The film according to claim 1, wherein the film (1) comprises at least one further outer layer for producing a mattness which has no fillers, the film (1) thereby having a haze value of more than 65%.

19. The film according to claim 1, wherein the at least one outer layer (3) has a proportion of polypropylene, the proportion being more than 5% by weight and less than 50% by weight.
